(19) United States
(12) Patent Application Publication
(10) Pub. No.: US 2014/0251519 A1
(43) Pub. Date: Sep. 11, 2014

(54) TIRE TREAD WITH IMPROVED SNOW/DRY TRACTION

(71) Applicant: Compagnie Generale des Etablissements Michelin, Clermont-Ferrand (FR)

(72) Inventors: Olivier Piffard, Mauldin, SC (US); Xavier Saintigny, Greenville, SC (US); Raymond Stubblefield, Greenville, SC (US); Cyril Guichon, Beauregard-Vendon (FR)

(21) Appl. No.: 14/241,911

(22) PCT Filed: Aug. 31, 2011
(86) PCT No.: PCT/US11/50042

§ 371 Date: Feb. 28, 2014

(51) Int. Cl. B60C 11/03; B60C 11/12; B60C 11/00

(52) U.S. Cl. CPC B60C 11/0318; B60C 11/0008; B60C 11/12; B60C 2011/0025; B60C 2011/129
USPC 152/209.5; 152/209.18

(57) ABSTRACT

Tire treads having one or more repeating pitches, each repeating pitch comprising individual pitches having tread blocks with sipes formed therein and each pitch having a pitch length of between 15 mm and 35 mm. Such treads may also have a weighted average sipe density D_{w} of between 10 mm⁻¹ and 37 mm⁻¹, which is determined through the disclosed Eq. 2 below. The tread blocks are also formed from a rubber composition based upon a diene elastomer, a plasticizing system and a cross-linking system, wherein the rubber composition has a glass transition temperature of between −40° C. and −15° C. and a shear modulus G* measured at 60° C. of between 0.5 MPa and 1.1 MPa.

### BACKGROUND OF THE INVENTION

1. Field of the Invention

This invention relates generally to tires for vehicles and more particularly, to tread sculpture and tread materials.

2. Description of the Related Art

It is known in the industry that tire designers must often compromise on certain characteristics of the tires they are designing. Changing a tire design to improve one characteristic of the tire will often result in a compromise; i.e., an offsetting decline in another tire characteristic. One such comprise exists between snow traction and dry braking. Snow traction may be improved by decreasing the glass transition temperature of the tread mix and/or by increasing the number of sipes in the tread. These moves, however, typically result in a decrease in dry braking performance that is known to be improved by increasing the glass transition temperature of the tread mix and/or by decreasing the number of sipes in the tread.

Tire designers and those conducting research in the tire industry search for materials and tire structures that can break some of the known compromises. It would be desirable to provide new tire designs that break the compromise between dry braking and snow traction.

### SUMMARY OF THE INVENTION

Particular embodiments of the present invention include treads and tires having such treads that provide a break in the compromise between dry braking and snow traction. Also included are methods for designing and manufacturing such treads and tires.

Embodiments include treads for a tire, the treads comprising one or more repeating pitches, each repeating pitch comprising individual pitches having tread blocks with sipes formed therein and disposed longitudinally along the tire tread. The pitch length in particular embodiments is between 15 mm and 35 mm. Such treads may also have a weighted average sipe density D_{w} of between 9 mm⁻¹ and 37 mm⁻¹, which is determined through Eq. 2 as disclosed below.

The treads may further be formed with tread blocks that comprise a rubber composition based upon a diene elastomer, a plasticizing system and a cross-linking system, wherein the rubber composition has a glass transition temperature of between −40° C. and −15° C. and a shear modulus G* measured at 60° C. of between 0.5 MPa and 1.1 MPa.

Particular embodiments may also include tread blocks having a contract surface adapted for contacting the road, wherein the contact surface of the tread blocks comprise the rubber composition based upon a diene elastomer, a plasticizing system and a cross-linking system, wherein the rubber composition has a glass transition temperature of between −40° C. and −15° C. and a shear modulus G* measured at 60° C. of between 0.5 MPa and 1.1 MPa. Some embodiments may include such tread blocks having at least 90 percent of the contact surface made entirely of the rubber composition.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1 is a plan view of an inked tire foot print taken at the maximum design load and pressure for a tire having a sculpture in accordance with an embodiment of the present invention.

FIG. 2 is a plan view of a pitch taken from the inked foot print shown in FIG. 1, showing a variety of pitch dimensions useful for determining sipe density.

FIG. 3 is a plan view of another example of a pitch taken from an inked foot print of a tire.

FIG. 4 is a graph showing the relationship between snow traction and dry braking.

### DETAILED DESCRIPTION OF PARTICULAR EMBODIMENTS

Tires are sometimes classified by the weather conditions for which their use was designed. For example, snow tires are designed to provide better traction on snow than other tires such as all-season tires and summer tires. Summer tires are designed for warm weather use and provide excellent dry traction but poor snow traction. All-season tires provide a compromise between summer and winter tires in that they provide somewhat better snow traction than summer tires and somewhat better dry traction than snow tires. This is a compromise that tire designers typically consider when designing tires—changes made in the design of a tire to improve snow traction typically result in a loss of dry braking performance.

The tire treads and tires disclosed herein surprisingly break this compromise so that the tread's snow traction is improved without a significant decline in the tread's dry braking performance. The compromise is broken through a unique combination of materials and sculpture design. The treads are made of a rubber composition having a low glass transition temperature (Tg) and are made with a tread sculpture that may be described as having a low sipe density. It is this combination of using a low Tg rubber composition to form a tread having a low sipe density that surprisingly contributes to the improved balance between snow and dry traction.

As used herein, the “longitudinal” direction is in the tire circumferential direction and is perpendicular to the tire axis of rotation.

As used herein, the “lateral” direction is along the tire width and is substantially parallel to the axis of rotation. However, as used herein, a “lateral groove” is any groove generally oriented at an angle less than 45 degrees with the purely lateral direction while a “longitudinal groove” is any groove generally oriented at an angle greater than or equal to 45 degrees with the purely lateral direction.

As used herein, a “tread element” is any type or shape of a structural feature found in the tread that contacts the ground. Examples of tread elements include tread blocks and tread ribs.

As used herein, a “tread block” is a tread element that has a perimeter defined by one or more grooves, creating an isolated structure in the tread.

As used herein, a “rib” is a tread element that runs substantially in the longitudinal direction of the tire and is not interrupted by any grooves that run in a substantially lateral direction or any other grooves oblique thereto.

As used herein, a “sipe” is a small slit that is molded or otherwise formed in a tread block or rib. A sipe may be straight, curved or otherwise formed in any geometrical shape.

As used herein, a “pitch” is a defined geometrical pattern that extends across the lateral width of the tread and is a member of the plurality of individual pitches that are disposed longitudinally along the entire tread length.

As used herein, a “repeating pitch” is a geometrical pattern that is repeated along the circumference of the tread and extends across the lateral width of the tread. Each repeating pitch is made up of a plurality of individual pitches that all have the same geometrical pattern. A tire may have one or more repeating pitches. When there is more than one repeating pitch, the different repeating pitches are often disposed so as to alternate with the others along the tread in some repeating pattern.

As used herein, “phr” is “parts per hundred parts of rubber by weight” and is a common measurement in the art wherein components of a rubber composition are measured relative to the total weight of rubber in the composition, i.e., parts by weight of the component per 100 parts by weight of the total rubber(s) in the composition.

As used herein, elastomer and rubber are synonymous terms.

As used herein, “based upon” is a term recognizing that embodiments of the present invention are made of vulcanized or cured rubber compositions that were, at the time of their assembly, uncured. The cured rubber composition is therefore “based upon” the uncured rubber composition. In other words, the cross-linked rubber composition is based upon or comprises the constituents of the cross-linkable rubber composition.

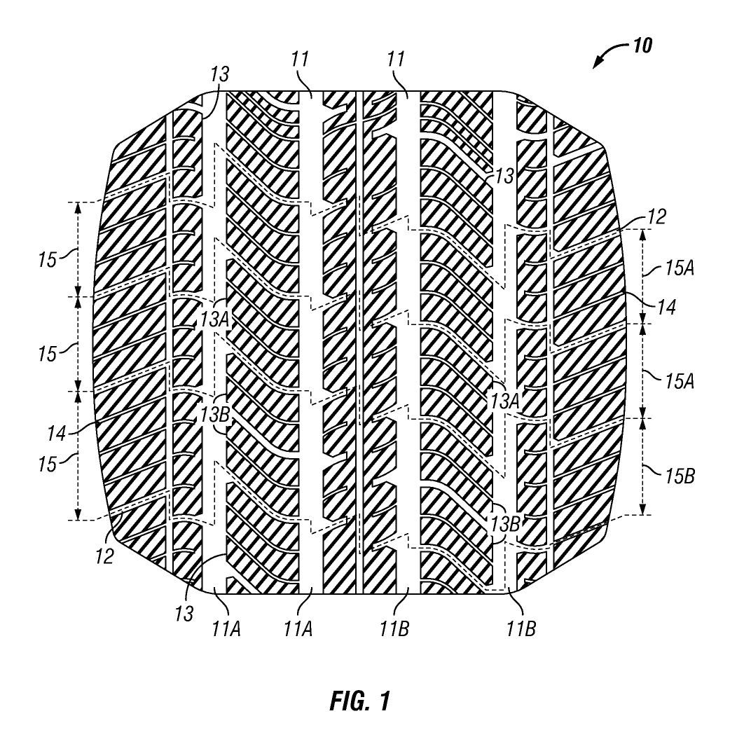

FIG. 1 is a plan view of an inked tire foot print taken at the maximum design load and pressure for a tire having a sculpture in accordance with an embodiment of the present invention. The inked tire foot print 10 may be taken by inking the tire tread and then imprinting the tire tread onto a piece of paper by pushing the inked tread against the paper at a set inflation pressure and load. For a passenger car, the foot print is taken at 85% of the maximum load as marked on the tire sidewall at an inflation pressure of 35 psig. For a light truck tire, the foot print it taken at 85% of the maximum load (single) at the inflation pressure associated with the maximum load (single), both as marked on the tire sidewall.

The inked tire foot print 10 shows the tread made up of longitudinal grooves 11 and lateral grooves 12 that form a plurality of tread blocks 13 in the tread. Each of the tread blocks 13 further include sipes 14 molded therein.

Pitches 15 are disposed longitudinally along the length of the inked foot print 10. The pitches 15 lie between the dotted lines in FIG. 1, which were added to aid in the differentiation of the pitches 15. There are two repeating pitches 15a, 15b shown in FIG. 1. As previously noted, a repeating pitch is defined as a geometrical pattern that is repeated along the circumference (longitudinally) of the tread and extends across the lateral width of the tread.

One of the most obvious differences between the two repeating pitches 15a, 15b is the number of tread blocks 13. In the first repeating pitch 15a, it is noted that that there is one tread block 13a between the two leftmost wide-longitudinal grooves 11a and between the two rightmost wide-longitudinal grooves 11b while in the second repeating pitch 15b, there are two tread blocks 13b between the same two pairs of longitudinal grooves 11a, 11b. Each of the repeating pitches 15a, 15b are made up of a plurality of pitches 15 that are disposed circumferentially along the entire tread length, typically in some alternating pattern.

As noted above, treads and tires of particular embodiments of the present invention may be described as having a sipe density falling within a given range. Sipe density provides an indication of the amount of siping on a tire. A high sipe density indicates there is much siping and a low sipe density indicates there is little siping. The sipe density is determined from the geometry and number of the pitches.

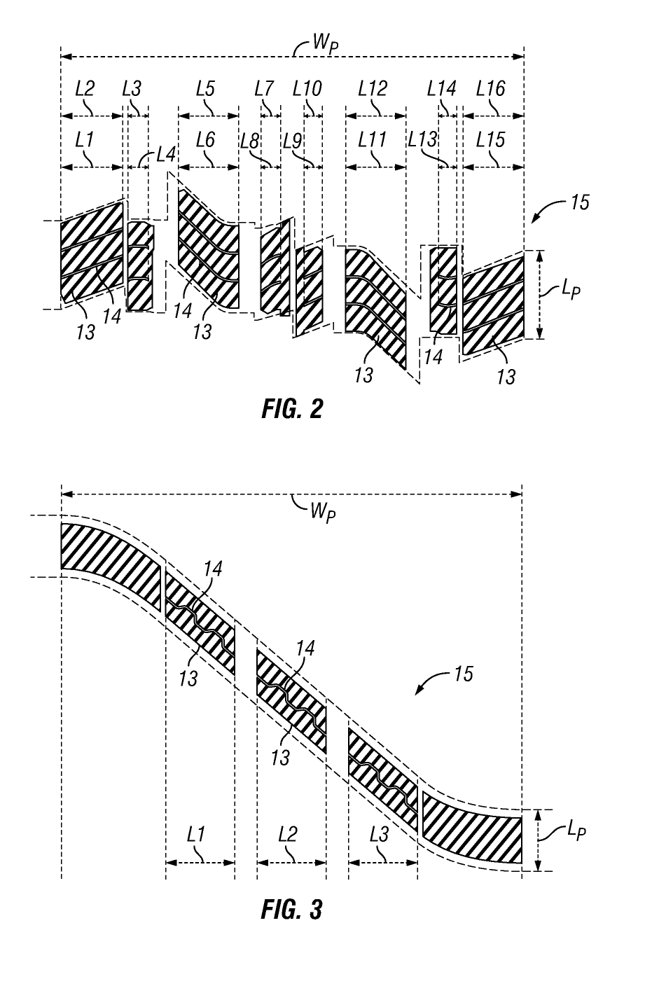

FIG. 2 is a plan view of a pitch taken from the inked foot print shown in FIG. 1, showing a variety of pitch dimensions useful for determining sipe density.

The useful dimensions of the pitch 15 include the pitch length Lₚ and the pitch width, Wₚ. The pitch length Lₚ is defined as the distance measured longitudinally at the tread edge between the beginning and the end of the pitch, e.g., for the exemplary pitch of FIG. 2, between the centers of the lateral grooves 12 defining the outermost tread block 13. The pitch width Wₚ is defined as the width of the tire tread measured across the lateral axis of the tread. The pitch width is the widest distance measured laterally across an inked tire footprint obtained as described above.

Another useful dimension of the pitches for determining sipe density is the laterally projected length L of each sipe 14. The projected length L of each sipe 14 is defined as the distance between the two ends of the sipe 14 measured along the lateral axis of the tread.

FIG. 3 is a plan view of another example of a pitch taken from an inked foot print of a tire. The pitch 15 shown herein has a pitch length Lₚ defined by the distance between the centers of the lateral grooves 12 defining the outermost tread block 13. The pitch width Wₚ is shown as the being the lateral distance across the width of the tread 15 and the laterally projected length L of each sipe 14 is shown as the distance between the two ends of the sipe 14 measured along the lateral axis of the tread.

The sipe density D_{R} may be determined for each repeating pitch on a given tread by the following equation (1):

$${D}_{R} = \frac{( {\sum }_{i = 1}^{n} {L}_{i} ) {P}_{R}}{{W}_{p} \times {L}_{p}} \times 1000 , \qquad Eq . ( 1 )$$

where, for one of the repeating pitches, n is a total number of sipes on one of the individual pitches making up the one repeating pitch, Lᵢ is a projected length of each sipe i onto a lateral axis of the tire tread, Wₚ is the pitch width, Lₚ is the pitch length and P_{R} is the number of individual pitches making up the one repeating pitch. The sipe density D_{R} units are inverse, e.g., if all the length measurements are in millimeters, then the sipe density units are mm⁻¹.

Particular embodiments of the tread disclosed herein may include one or more repeating pitches. If there is only one repeating pitch, then the sipe density D_{R} defined by Equation (1) provides the sipe density for the tread. However, if there is more than one repeating pitches in a given tread design, then the sipe density for the tread may be expressed as the weighted average sipe density D_{w} of each of the repeating pitches. The weighted average sipe density D_{w} is defined by the following Equation (2):

$${D}_{w} = \frac{{\sum }_{i = 1}^{n} ( {( {D}_{R} )}_{i} \times {P}_{i} \times {( {L}_{p} )}_{i} )}{{\sum }_{i = 1}^{n} ( {P}_{i} \times {( {L}_{p} )}_{i} )} , \qquad Eq . ( 2 )$$

where n is the number of repeating pitches in the tread and, for each of the repeating pitches, (D_{R})ᵢ is the sipe density provided from Eq. (1), Pᵢ is the number of pitches in in the repeating pitch and (Lₚ)ᵢ is the pitch length. Of course, for n=1, D_{w}=D_{R}, wherein D_{R} is the result from Eq. (1).

For particular embodiments of the present invention, the weighted average sipe density is between 9 mm⁻¹ and 37 mm⁻¹ or alternatively between 10 mm⁻¹ and 30 mm⁻¹ or between 10 mm⁻¹ and 27 mm⁻¹, between 15 mm⁻¹ and 30 mm⁻¹ or between 20 mm⁻¹ and 30 mm⁻¹. Embodiments may include having pitch lengths of between 15 mm and 35 mm or alternatively, between 19 mm and 29 mm. As the weighted average sipe density or the pitch lengths move out of these defined ranges, the benefit of breaking the compromise between dry traction and snow traction may be reduced or lost.

As has been noted, particular embodiments of the present invention surprisingly break the compromise between the dry and snow traction through a unique combination of materials and sculpture design. The sculpture design has been discussed above and it has been disclosed that such sculptures provide a combination of a weighted sipe density with a given range of the number of pitches that are disposed about the tire tread.

In addition to this sculpture, the materials component of the tire treads that break the compromise between dry and snow traction includes forming the treads from a rubber composition having a low glass transition temperature (Tg), e.g., between −40° C. and −15° C. or alternatively, between −40° C. and −25° C., between −35° C. and −20° C. or between −35° C. and −25° C.

In particular embodiments, such low Tg rubber composition may further be characterized as having a shear modulus G* measured at 60° C. of between 0.5 MPa and 1.1 MPa or alternatively, between 0.5 MPa and 1 MPa or 0.6 MPa and 0.9 MPa. The discussion below will detail suitable compositions for making the treads.

Suitable compositions for making the treads include those rubber compositions having a glass transition temperature within a defined range, said rubber compositions being based upon a diene elastomer, a plasticizing system and a cross-linking system. The diene elastomers or rubbers that are useful for such rubber compositions are understood to be those elastomers resulting at least in part, i.e., a homopolymer or a copolymer, from diene monomers, i.e., monomers having two double carbon-carbon bonds, whether conjugated or not.

These diene elastomers may be classified as either “essentially unsaturated” diene elastomers or “essentially saturated” diene elastomers. As used herein, essentially unsaturated diene elastomers are diene elastomers resulting at least in part from conjugated diene monomers, the essentially unsaturated diene elastomers having a content of such members or units of diene origin (conjugated dienes) that is at least 15 mol. %. Within the category of essentially unsaturated diene elastomers are highly unsaturated diene elastomers, which are diene elastomers having a content of units of diene origin (conjugated diene) that is greater than 50 mol. %.

Those diene elastomers that do not fall into the definition of being essentially unsaturated are, therefore, the essentially saturated diene elastomers. Such elastomers include, for example, butyl rubbers and copolymers of dienes and of alpha-olefins of the EPDM type. These diene elastomers have low or very low content of units of diene origin (conjugated dienes), such content being less than 15 mol. %.

Examples of suitable conjugated dienes include, in particular, 1,3-butadiene, 2-methyl-1,3-butadiene, 2,3-di(C₁-C₅ alkyl)-1,3-butadienes such as, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Examples of vinyl-aromatic compounds include styrene, ortho-, meta- and para-methylstyrene, the commercial mixture “vinyltoluene”, para-tert-butylstyrene, methoxystyrenes, chloro-styrenes, vinylmesitylene, divinylbenzene and vinylnaphthalene.

The copolymers may contain between 99 wt. % and 20 wt. % of diene units and between 1 wt. % and 80 wt. % of vinyl-aromatic units. The elastomers may have any microstructure, which is a function of the polymerization conditions used, in particular of the presence or absence of a modifying and/or randomizing agent and the quantities of modifying and/or randomizing agent used. The elastomers may, for example, be block, random, sequential or micro-sequential elastomers, and may be prepared in dispersion or in solution; they may be coupled and/or starred or alternatively functionalized with a coupling and/or starring or functionalizing agent.

Examples of suitable diene elastomers include polybutadienes, particularly those having a content of 1,2-units of between 4 mol. % and 80 mol. % or those having a cis-1,4 content of more than 80 mol. %. Also included are polyisoprenes and butadiene/styrene copolymers, particularly those having a styrene content of between 5 wt. % and 50 wt. % or of between 20 wt. % and 40 wt. % and in the butadiene faction, a content of 1,2-bonds of between 4 mol. % and 65 mol. %, a content of trans-1,4 bonds of between 20 mol. % and 80 mol. %. Also included are butadiene/isoprene copolymers, particularly those having an isoprene content of between 5 wt. % and 90 wt. % and a glass transition temperature (Tg, measured in accordance with ASTM D3418) of −40° C. to −80° C.

Further included are isoprene/styrene copolymers, particularly those having a styrene content of between 5 wt. % and 50 wt. % and a Tg of between −25° C. and −50° C. In the case of butadiene/styrene/isoprene copolymers, examples of those which are suitable include those having a styrene content of between 5 wt. % and 50 wt. % and more particularly between 10 wt. % and 40 wt. %, an isoprene content of between 15 wt. % and 60 wt. %, and more particularly between 20 wt. % and 50 wt. %, a butadiene content of between 5 wt. % and 50 wt. % and more particularly between 20 wt. % and 40 wt. %, a content of 1,2-units of the butadiene fraction of between 4 wt. % and 85 wt. %, a content of trans-1,4 units of the butadiene fraction of between 6 wt. % and 80 wt. %, a content of 1,2-plus 3,4-units of the isoprene fraction of between 5 wt. % and 70 wt. %, and a content of trans-1,4 units of the isoprene fraction of between 10 wt. % and 50 wt. %, and more generally any butadiene/styrene/isoprene copolymer having a Tg of between −20° C. and −70° C.

The diene elastomers used in particular embodiments of the present invention may further be functionalized, i.e., appended with active moieties. Examples of functionalized elastomers include silanol end-functionalized elastomers that are well known in the industry. Examples of such materials and their methods of making may be found in U.S. Pat. No. 6,013,718, issued Jan. 11, 2000, which is hereby fully incorporated by reference.

The silanol end-functionalized SBR used in particular embodiments of the present invention may be characterized as having a glass transition temperature Tg, for example, of between −50° C. and −10° C. or alternatively between −40° C. and −15° C. or between −30° C. and −20° C. as determined by differential scanning calorimetry (DSC) according to ASTM E1356. The styrene content, for example, may be between 15% and 30% by weight or alternatively between 20% and 30% by weight with the vinyl content of the butadiene part, for example, being between 25% and 70% or alternatively, between 40% and 65% or between 50% and 60%.

In summary, suitable diene elastomers for particular embodiments of the present invention include highly unsaturated diene elastomers such as polybutadienes (BR), polyisoprenes (IR), natural rubber (NR), butadiene copolymers, isoprene copolymers and mixtures of these elastomers. Such copolymers include butadiene/styrene copolymers (SBR), isoprene/butadiene copolymers (BIR), isoprene/styrene copolymers (SIR) and isoprene/butadiene/styrene copolymers (SBIR). Suitable elastomers may also include any of these elastomers being functionalized elastomers.

Particular embodiments of the present invention may contain only one diene elastomer and/or a mixture of several diene elastomers. While some embodiments are limited only to the use of one or more highly unsaturated diene elastomers, other embodiments may include the use of diene elastomers mixed with any type of synthetic elastomer other than a diene elastomer or even with polymers other than elastomers as, for example, thermoplastic polymers.

In addition to the rubber, the rubber composition disclosed herein may further include a reinforcing filler. Reinforcing fillers are added to rubber compositions to, inter alia, improve their tensile strength and wear resistance. Any suitable reinforcing filler may be suitable for use in compositions disclosed herein including, for example, carbon blacks and/or inorganic reinforcing fillers such as silica, with which a coupling agent is typically associated.

Suitable carbon blacks include, for example, those of the type HAF, ISAF and SAF, conventionally used in tires. Reinforcing blacks of ASTM grade series 100, 200 and/or 300 are suitable such as, for example, the blacks N115, N134, N234, N330, N339, N347, N375 or alternatively, depending on the intended application, blacks of higher ASTM grade series such as N660, N683 and N772.

Inorganic reinforcing fillers include any inorganic or mineral fillers, whatever its color or origin (natural or synthetic), that are capable without any other means, other than an intermediate coupling agent, or reinforcing a rubber composition intended for the manufacture of tires. Such inorganic reinforcing fillers can replace conventional tire-grade carbon blacks, in whole or in part, in a rubber composition intended for the manufacture of tires. Typically such fillers may be characterized as having the presence of hydroxyl (—OH) groups on its surface.

Inorganic reinforcing fillers may take many useful forms including, for example, as powder, microbeads, granules, balls and/or any other suitable form as well as mixtures thereof. Examples of suitable inorganic reinforcing fillers include mineral fillers of the siliceous type, such as silica (SiO₂), of the aluminous type, such as alumina (AlO₃) or combinations thereof.

Useful silica reinforcing fillers known in the art include fumed, precipitated and/or highly dispersible silica (known as “HD” silica). Examples of highly dispersible silicas include Ultrasil 7000 and Ultrasil 7005 from Degussa, the silicas Zeosil 1165MP, 1135MP and 1115MP from Rhodia, the silica Hi-Sil EZ150G from PPG and the silicas Zeopol 8715, 8745 and 8755 from Huber. In particular embodiments, the silica may have a BET surface area, for example, of between 60 m²/g and 250 m²/g or alternatively between 80 m²/g and 230 m²/g.

Examples of useful reinforcing aluminas are the aluminas Baikalox A125 or CR125 from Baikowski, APA-100RDX from Condea, Aluminoxid C from Degussa or AKP-G015 from Sumitomo Chemicals.

For coupling the inorganic reinforcing filler to the diene elastomer, a coupling agent that is at least bifunctional provides a sufficient chemical and/or physical connection between the inorganic reinforcement filler and the diene elastomer. Examples of such coupling agents include bifunctional organosilanes or polyorganosiloxanes. Such coupling agents and their use are well known in the art. The coupling agent may optionally be grafted beforehand onto the diene elastomer or onto the inorganic reinforcing filler as is known. Otherwise it may be mixed into the rubber composition in its free or non-grafted state. One useful coupling agent is X 50-S, a 50-50 blend by weight of Si69 (the active ingredient) and N330 carbon black, available from Evonik Degussa.

In the rubber compositions according to the invention, the content of coupling agent is preferably between 2 and 15 phr, more preferably between 4 and 12 phr (for example between 3 and 8 phr). However, it is generally desirable to minimize its use. The amount of coupling agent typically represents between 0.5 and 15 wt. % relative to the total weight of the reinforcing inorganic filler. In the case for example of tire treads for passenger vehicles, the coupling agent may be less than 12 wt. % or even less than 10 wt. % relative to the total weight of reinforcing inorganic filler.

In particular embodiments, the amount of total reinforcing filler (carbon black and/or reinforcing inorganic filler) is between 20 phr and 200 phr or alternatively between 30 phr and 150 phr or between 50 phr and 110 phr.

In addition to the diene elastomer and reinforcing filler, particular embodiments of the rubber composition disclosed herein may further include a plasticizing system. The plasticizing system may provide both an improvement to the processability of the rubber mix and/or a means for adjusting the rubber composition's glass transition temperature and/or rigidity. Suitable plasticizing systems may include a processing oil, plasticizing resin or combinations thereof.

Suitable processing oils may include those derived from petroleum stocks, those having a vegetable base and combinations thereof. Examples of oils that are petroleum based include aromatic oils, paraffinic oils, naphthenic oils, MES oils, TDAE oils and so forth as known in the industry.

Examples of suitable vegetable oils include sunflower oil, soybean oil, safflower oil, corn oil, linseed oil and cotton seed oil. These oils and other such vegetable oils may be used singularly or in combination. In some embodiments, sunflower oil having a high oleic acid content (at least 70 weight percent or alternatively, at least 80 weight percent) is useful, an example being AGRI-PURE 80, available from Cargill with offices in Minneapolis, Minn.

A plasticizing hydrocarbon resin is a hydrocarbon compound that is solid at ambient temperature (e.g., 23° C.) as opposed to a liquid plasticizing compound, such as a plasticizing oil. Additionally a plasticizing hydrocarbon resin is compatible, i.e., miscible, with the rubber composition with which the resin is mixed at a concentration that allows the resin to act as a true plasticizing agent, e.g., at a concentration that is typically at least 5 phr (parts per hundred parts rubber by weight) or even much higher.

Plasticizing hydrocarbon resins are polymers that can be aliphatic, aromatic or combinations of these types, meaning that the polymeric base of the resin may be formed from aliphatic and/or aromatic monomers. These resins can be natural or synthetic materials and can be petroleum based, in which case the resins may be called petroleum plasticizing resins, or based on plant materials. In particular embodiments, although not limiting the invention, these resins may contain essentially only hydrogen and carbon atoms.

The plasticizing hydrocarbon resins useful in particular embodiment of the present invention include those that are homopolymers or copolymers of cyclopentadiene (CPD) or dicyclopentadiene (DCPD), homopolymers or copolymers of terpene, homopolymers or copolymers of C₅ cut and mixtures thereof.

Such copolymer plasticizing hydrocarbon resins as discussed generally above may include, for example, resins made up of copolymers of (D)CPD/vinyl-aromatic, of (D)CPD/terpene, of (D)CPD/C₅ cut, of terpene/vinyl-aromatic, of C₅ cut/vinyl-aromatic and of combinations thereof.

Terpene monomers useful for the terpene homopolymer and copolymer resins include alpha-pinene, beta-pinene and limonene. Particular embodiments include polymers of the limonene monomers that include three isomers: the L-limonene (levorotatory enantiomer), the D-limonene (dextrorotatory enantiomer), or even the dipentene, a racemic mixture of the dextrorotatory and laevorotatory enantiomers.

Examples of vinyl aromatic monomers include styrene, alpha-methylstyrene, ortho-, meta-, para-methylstyrene, vinyl-toluene, para-tertiobutylstyrene, methoxystyrenes, chloro-styrenes, vinyl-mesitylene, divinylbenzene, vinylnaphthalene, any vinyl-aromatic monomer coming from the C₉ cut (or, more generally, from a C₈ to C₁₀ cut). Particular embodiments that include a vinyl-aromatic copolymer include the vinyl-aromatic in the minority monomer, expressed in molar fraction, in the copolymer.

Particular embodiments of the present invention include as the plasticizing hydrocarbon resin the (D)CPD homopolymer resins, the (D)CPD/styrene copolymer resins, the polylimonene resins, the limonene/styrene copolymer resins, the limonene/D(CPD) copolymer resins, C₅ cut/styrene copolymer resins, C₅ cut/C₉ cut copolymer resins, and mixtures thereof.

Commercially available plasticizing resins that include terpene resins suitable for use in the present invention include a polyalphapinene resin marketed under the name Resin R2495 by Hercules Inc. of Wilmington, Del. Resin R2495 has a molecular weight of about 932, a softening point of about 135° C. and a glass transition temperature of about 91° C. Another commercially available product that may be used in the present invention includes DERCOLYTE L120 sold by the company DRT of France. DERCOLYTE L120 polyterpene-limonene resin has a number average molecular weight of about 625, a weight average molecular weight of about 1010, an Ip of about 1.6, a softening point of about 119° C. and has a glass transition temperature of about 72° C. Still another commercially available terpene resin that may be used in the present invention includes SYLVARES TR 7125 and/or SYLVARES TR 5147 polylimonene resin sold by the Arizona Chemical Company of Jacksonville, Fla. SYLVARES 7125 polylimonene resin has a molecular weight of about 1090, has a softening point of about 125° C., and has a glass transition temperature of about 73° C. while the SYLVARES TR 5147 has a molecular weight of about 945, a softening point of about 120° C. and has a glass transition temperature of about 71° C.

Other suitable plasticizing hydrocarbon resins that are commercially available include C₅ cut/vinyl-aromatic styrene copolymer, notably C₅ cut/styrene or C₅ cut/C₉ cut from Neville Chemical Company under the names SUPER NEVTAC 78, SUPER NEVTAC 85 and SUPER NEVTAC 99; from Goodyear Chemicals under the name WINGTACK EXTRA; from Kolon under names HIKOREZ T1095 and HIKOREZ T1100; and from Exxon under names ESCOREZ 2101 and ECR 373.

Yet other suitable plasticizing hydrocarbon resins that are limonene/styrene copolymer resins that are commercially available include DERCOLYTE TS 105 from DRT of France; and from Arizona Chemical Company under the name ZT115LT and ZT5100.

It may be noted that the glass transition temperatures of plasticizing resins may be measured by Differential Scanning calorimetry (DCS) in accordance with ASTM D3418 (1999). In particular embodiments, useful resins may be have a glass transition temperature that is at least 25° C. or alternatively, at least 40° C. or at least 60° C. or between 25° C. and 95° C., between 40° C. and 85° C. or between 60° C. and 80° C.

The amount of plasticizing hydrocarbon resin useful in any particular embodiment of the present invention depends upon the particular circumstances and the desired result. In general, for example, the plasticizing hydrocarbon resin may be present in the rubber composition in an amount of between 5 phr and 60 phr or alternatively, between 10 phr and 50 phr. In particular embodiments, the plasticizing hydrocarbon resin may be present in an amount of between 10 phr and 60 phr, between 15 phr and 55 phr or between 15 phr and 50 phr.

The rubber compositions disclosed herein may be cured with any suitable curing system including a peroxide curing system or a sulfur curing system. Particular embodiments are cured with a sulfur curing system that includes free sulfur and may further include, for example, one or more of accelerators, stearic acid and zinc oxide. Suitable free sulfur includes, for example, pulverized sulfur, rubber maker's sulfur, commercial sulfur, and insoluble sulfur. The amount of free sulfur included in the rubber composition is not limited and may range, for example, between 0.5 phr and 10 phr or alternatively between 0.5 phr and 5 phr or between 0.5 phr and 3 phr. Particular embodiments may include no free sulfur added in the curing system but instead include sulfur donors.

Accelerators are used to control the time and/or temperature required for vulcanization and to improve the properties of the cured rubber composition. Particular embodiments of the present invention include one or more accelerators. One example of a suitable primary accelerator useful in the present invention is a sulfenamide. Examples of suitable sulfenamide accelerators include n-cyclohexyl -2-benzothiazole sulfenamide (CBS), N-tert-butyl-2-benzothiazole Sulfenamide (TBBS), N-Oxydiethyl-2-benzthiazolsulfenamid (MBS) and N′-dicyclohexyl-2-benzothiazolesulfenamide (DCBS). Combinations of accelerators are often useful to improve the properties of the cured rubber composition and the particular embodiments include the addition of secondary accelerators.

Particular embodiments may include as a secondary accelerant the use of a moderately fast accelerator such as, for example, diphenylguanidine (DPG), triphenyl guanidine (TPG), diorthotolyl guanidine (DOTG), o-tolylbigaunide (OTBG) or hexamethylene tetramine (HMTA). Such accelerators may be added in an amount of up to 4 phr, between 0.5 and 3 phr, between 0.5 and 2.5 phr or between 1 and 2 phr. Particular embodiments may exclude the use of fast accelerators and/or ultra-fast accelerators such as, for example, the fast accelerators: disulfides and benzothiazoles; and the ultra-accelerators: thiurams, xanthates, dithiocarbamates and dithiophosphates.

Other additives can be added to the rubber compositions disclosed herein as known in the art. Such additives may include, for example, some or all of the following: antidegradants, antioxidants, fatty acids, waxes, stearic acid and zinc oxide. Examples of antidegradants and antioxidants include 6PPD, 77PD, IPPD and TMQ and may be added to rubber compositions in an amount, for example, of from 0.5 phr and 5 phr. Zinc oxide may be added in an amount, for example, of between 1 phr and 6 phr or alternatively, of between 1.5 phr and 4 phr. Waxes may be added in an amount, for example, of between 1 phr and 5 phr.

The rubber compositions that are embodiments of the present invention may be produced in suitable mixers, in a manner known to those having ordinary skill in the art, typically using two successive preparation phases, a first phase of thermo-mechanical working at high temperature, followed by a second phase of mechanical working at lower temperature.

The first phase of thermo-mechanical working (sometimes referred to as “non-productive” phase) is intended to mix thoroughly, by kneading, the various ingredients of the composition, with the exception of the vulcanization system. It is carried out in a suitable kneading device, such as an internal mixer or an extruder, until, under the action of the mechanical working and the high shearing imposed on the mixture, a maximum temperature generally between 120° C. and 190° C., more narrowly between 130° C. and 170° C., is reached.

After cooling of the mixture, a second phase of mechanical working is implemented at a lower temperature. Sometimes referred to as “productive” phase, this finishing phase consists of incorporating by mixing the vulcanization (or cross-linking) system (sulfur or other vulcanizing agent and accelerator(s)), in a suitable device, for example an open mill. It is performed for an appropriate time (typically between 1 and 30 minutes, for example between 2 and 10 minutes) and at a sufficiently low temperature lower than the vulcanization temperature of the mixture, so as to protect against premature vulcanization.

The rubber composition can be formed into useful articles, including treads for use on vehicle tires. The treads may be formed as tread bands and then later made a part of a tire or they be formed directly onto a tire carcass by, for example, extrusion and then cured in a mold. As such, tread bands may be cured before being disposed on a tire carcass or they may be cured after being disposed on the tire carcass. Typically a tire tread is cured in a known manner in a mold that molds the tread elements into the tread, including, e.g., the sipes molded into the tread blocks.

It is recognized that treads may be formed from only one rubber composition or in two or more layers of differing rubber compositions, e.g., a cap and base construction. In a cap and base construction, the cap portion of the tread is made of one rubber composition that is designed for contact with the road. The cap is supported on the base portion of the tread, the base portion made of a different rubber composition. In particular embodiments of the present invention the entire tread may be made from the rubber compositions as disclosed herein while in other embodiments only the cap portions of the tread may be made from such rubber compositions.

It is recognized that the contact surface of a tread block, i.e., that portion of the tread block that contacts the road, may be formed totally from the rubber composition having the low Tg as disclosed herein, may be formed totally from another rubber composition or may be formed as combinations thereof. For example, a tread block may be formed as a composite of layered rubber compositions such that half of the block laterally is a layer of the low Tg rubber composition and the other half of the block laterally is a layer of an alternative rubber composition. Such construction would provide a tread block having at least 80 percent of its contact surface formed of the low Tg rubber composition.

As such, in particular embodiments of the present invention, at least 80 percent of the total contact surface of all the tread blocks on a tread may be formed from the rubber composition having the low Tg as disclosed herein. Alternatively, at least 85 percent, at least 95 percent or 100 percent of the total contact surface of all the tread blocks on a tread may be formed from such rubber composition.

While the tire treads disclosed herein are suitable for many types of vehicles, particular embodiments include tire treads for use on vehicles such as passenger cars and/or light trucks. Such tire treads are also useful for all weather tires and/or snow tires.

Particular embodiments of the present invention may further include methods for designing and manufacturing the tires and treads as disclosed herein. Such methods may include the steps of designing one or more repeating pitches that each comprises individual pitches having tread blocks with sipes formed therein and disposed longitudinally along the tire tread. The method may further include providing a design that includes a total of at least 65 individual pitches making up the one or more repeating pitches.

Such methods may further include the step of determining a number of the sipes in the tread design so that the tread has a weighted average sipe density D_{w} of between 15 mm⁻¹ and 27 mm⁻¹, D_{w} and D_{R} both being defined herein. Other steps in such methods may include specifying a rubber composition for forming the tread blocks, wherein the rubber composition is a rubber composition based upon a diene elastomer, a plasticizing system and a cross-linking system, wherein the rubber composition has a glass transition temperature of between −30° C. and −15° C. and a shear modulus G* measured at 60° C. of between 0.5 MPa and 1.5 MPa and may further include mixing and/or curing such rubber composition.

Particular embodiments of such methods may further include forming a tread with the determined number of pitches and sipes from the specified rubber composition. Other steps may include designing or designating that the tread blocks have a contact surface that is made entirely of the specified rubber composition or alternatively, at least 90 percent of the contract surface area is made entirely of the specified rubber composition.

The step of forming the tread may further include molding the tread or extruding the tread.

The invention is further illustrated by the following examples, which are to be regarded only as illustrations and not delimitative of the invention in any way. The properties of the compositions disclosed in the examples were evaluated as described below and these utilized methods are suitable for measurement of the claimed properties of the present invention.

Modulus of elongation (MPa) was measured at 10% (MA10) at a temperature of 23° C. based on ASTM Standard D412 on dumb bell test pieces. The measurements were taken in the second elongation; i.e., after an accommodation cycle. These measurements are secant moduli in MPa, based on the original cross section of the test piece.

Snow grip (%) on snow-covered ground was evaluated by measuring the forces on a single driven test tire in snow according to the ASTM F1805 test method. The vehicle travels at a constant 5 mph speed and the forces are measured on the single test tire at the target slip. A value greater than that of the Standard Reference Test Tire (SRTT), which is arbitrarily set to 100, indicates an improved result, i.e., improved grip on snow.

Dry grip performance (%) of a tire mounted on an automobile fitted with an ABS braking system was measured by determining the distance necessary to go from 60 mph to a complete stop upon sudden braking on a dry asphalt surface. A value greater than that of the control, which is arbitrarily set to 100, indicates an improved result, i.e., a shorter braking distance and improved dry grip.

Shore A hardness of the compositions after curing was assessed in accordance with ASTM Standard D 2240-86.

The maximum tan delta dynamic properties for the rubber compositions were measured at 23° C. on a Metravib Model VA400 ViscoAnalyzer Test System in accordance with ASTM D5992-96. The response of a sample of vulcanized material (double shear geometry with each of the two 10 mm diameter cylindrical samples being 2 mm thick) was recorded as it was being subjected to an alternating single sinusoidal shearing stress at a frequency of 10 Hz under a controlled temperature of 23° C. Scanning was effected at an amplitude of deformation of 0.05 to 50% (outward cycle) and then of 50% to 0.05% (return cycle). The maximum value of the tangent of the loss angle tan delta (max tan δ) was determined during the return cycle.

Dynamic properties (Tg and G*) for the rubber compositions were measured on a Metravib Model VA400 ViscoAnalyzer Test System in accordance with ASTM D5992-96. The response of a sample of vulcanized material (double shear geometry with each of the two 10 mm diameter cylindrical samples being 2 mm thick) was recorded as it was being subjected to an alternating single sinusoidal shearing stress of a constant 0.7 MPa and at a frequency of 10 Hz over a temperature sweep from −60° C. to 100° C. with the temperature increasing at a rate of 1.5° C./min. The shear modulus G* at 60° C. was captured and the temperature at which the max tan delta occurred was recorded as the glass transition temperature, Tg.

### EXAMPLE 1

Rubber compositions were prepared using the components shown in Table 1. The amount of each component making up the rubber compositions shown in Table 1 are provided in parts per hundred parts of rubber by weight (phr). The SBR was an oil extended rubber (with 10 phr MES) having a Tg of −27° C. and the BR had a Tg of −104° C.

The terpene resin was SYLVARES TR-5147, a polylimonene resin available from Arizona Chemical, Savannah, Ga. The plasticizing oil was naphthenic oil and/or sunflower oil. The silica was ZEOSIL 160, a highly dispersible silica available from Rhodia having a BET of 160 m²/g. The silane coupling agent was X 50-S available from Evonik Degussa. The curative package included sulfur, accelerators, zinc oxide and stearic acid.

The rubber formulations were prepared by mixing the components given in Table 1, except for the sulfur and the accelerators, in a Banbury mixer operating between 25 and 65 RPM until a temperature of between 130° C. and 170° C. was reached. The accelerators and sulfur were added in the second phase on a mill. Vulcanization was effected at 150° C. for 40 minutes. The formulations were then tested to measure their physical properties, which are reported in Table 2.

TABLE 1
Rubber Formulations

| Formulations | F1 | F2 | F3 |
|---|---|---|---|
| BR | 46.5 | 46.5 | 49.5 |
| SBR | 58.85 | 58.85 | 55.55 |
| Silica | 75 | 75 | 75 |
| Plasticizing Oil | 6.2 | 16.5 | 19.3 |
| Polyterpene Resin | 39.7 | 26.4 | 22.4 |
| Silane Coupling Agent | 12 | 12 | 12 |
| Additives (Wax & 6PPD) | 3.4 | 3.4 | 3.4 |
| Curing Package | 8 | 8 | 8 |

TABLE 2
Properties

| Physical Properties | F1 | F2 | F3 |
|---|---|---|---|
| MA10 @ 23° C. (MPa) | 2.97 | 2.61 | 2.45 |
| Modulus G* @ 60° C. | 0.84 | 0.79 | 0.82 |
| Max Tan Delta @ 23° C. | 0.33 | 0.26 | 0.26 |
| Tg, ° C. | −14 | −21 | −31 |
| Shore Hardness A | 59 | 57 | 57 |

The first formulation F1 has a Tg of −14° C. that may typically be suitable for a summer tire. The second formulation F2 has a Tg of −21° C. that may typically be suitable for an all season tire. The third formulation F3 has a Tg of −31, a low Tg typically used for a winter tire. The amount of plasticizing oils and resin were adjusted to maintain a fairly constant modulus while adjusting the Tg of the rubber compositions.

Tires T1-T5 were manufactured (245/45R17) using the formulations shown in Table 1 to form the treads. The tires were produced with sipe densities of 75 mm⁻¹, 50 mm⁻¹ and 25 mm⁻¹ and tested on a test car using the test procedures described above. The tire test results are shown in Table 3.

TABLE 4
Tire Test Results

| | T1 | T2 | T3 | T4 | T5 |
|---|---|---|---|---|---|
| Formulation | F3 | F2 | F1 | F1 | F3 |
| Tg, ° C. | −31 | −21 | −14 | −14 | −31 |
| Sipe Density, mm⁻¹ | 75 | 50 | 25 | 75 | 25 |
| Snow Traction, % | 128 | 73 | 43 | 81 | 84 |
| Dry Traction, % | 95 | 102 | 108 | 99 | 103 |

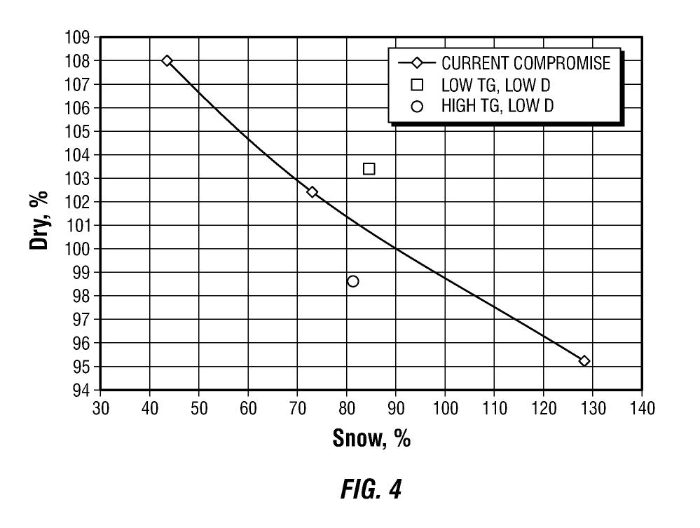

FIG. 4 is a graph showing the relationship between snow traction and dry braking based on the tire results from Table 2. The known compromise is shown in FIG. 4 by plotting the test results from a winter tire T1 (low Tg composition F3 with a high sipe density 75 mm−1), an all season tire T2 (medium Tg composition F2 with a medium sipe density 50 mm⁻¹) and a summer tire T3 (high Tg composition F1 with a low sipe density. The fourth tire T4 demonstrates the poor performance from a tire tread formed from a rubber composition having a high Tg and having a high sipe density tread sculpture. Surprisingly, the results obtained from the tire T5 having a tread formed from a rubber composition having a low Tg and having a low sipe density tread sculpture demonstrated that such design breaks the compromise between snow/dry traction by providing a tire that, in comparison to the all season tire T2, maintains its dry traction performance while improving its snow traction performance by 15 percent.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A tread for a tire, the tread comprising:
one or more repeating pitches, each repeating pitch comprising individual pitches having tread blocks with sipes formed therein and disposed longitudinally along the tire tread, each pitch having a pitch length of between 15 mm and 35 mm;
wherein the tread has a weighted average sipe density D_{w} of between 9 mm⁻¹ and 37 mm⁻¹, wherein a sipe density D_{R} for each of the one or more repeating pitches is:
$${D}_{R} = \frac{( {\sum }_{i = 1}^{n} {L}_{i} ) {P}_{R}}{{W}_{p} \times {L}_{p}} \times 1000 ,$$
where, for one repeating pitch, n is a total number of sipes on one of the individual pitches making up the one repeating pitch, Lᵢ is a projected length of each sipe i onto a lateral axis of the tire tread, Wₚ is a pitch width, Lₚ is the pitch length and P_{R} is a number of individual pitches making up the one repeating pitch, and
wherein the tread blocks comprise a rubber composition based upon a diene elastomer, a plasticizing system and a cross-linking system, wherein the rubber composition has a glass transition temperature of between −40° C. and −15° C. and a shear modulus G* measured at 60° C. of between 0.5 MPa and 1.1 MPa.

2. The tread of claim 1, wherein there is one repeating pitch.

3. The tread of claim 1, wherein there are between 2 and 5 repeating pitches.

4. The tread of claim 3, wherein the individual pitches from each of the repeating pitches alternate in a pattern along the entire tire tread.

5. The tread of claim 1, wherein the pitch length is between 19 mm and 29 mm.

6. The tread of claim 1, wherein the shear modulus G* measured at 60° C. of between 0.5 MPa and 0.9 MPa.

7. The tread of claim 1, wherein D_{w} is between 20 mm⁻¹ and 30 mm⁻¹.

8. The tread of claim 1, wherein the glass transition temperature of the rubber composition is between −35° C. and −25° C.

9. The tread of claim 1, wherein the glass transition temperature of the rubber composition is between −40° C. and −25° C.

10. The tread of claim 1, wherein the shear modulus G* is between 0.5 MPa and 1 MPa.

11. The tread of claim 1, wherein the diene elastomer is selected from natural rubber, styrene-butadiene rubber, synthetic polyisoprene rubber, polybutadiene rubber and combinations thereof.

12. The tread of claim 1, wherein the plasticizing system comprises plasticizers selected from a plasticizing oil, a plasticizing resin or combinations thereof.

13. The tread of claim 11, wherein the plasticizing resin is a polylimonene resin.

14. The tread of claim 11, wherein the plasticizing oil is selected from a petroleum based oil, a vegetable oil or combinations thereof.

15. The tread of claim 1, further comprising:
additional tread blocks formed in one or more of the individual pitches, the additional tread blocks comprising a second rubber composition, wherein at least 80 percent of a total contact surface of all the tread blocks on the tread are formed from the rubber composition.

16. The tread of claim 1, wherein the tread blocks further comprise a second rubber composition, wherein at least 80 percent of a total contact surface of all the tread blocks on the tread are formed from the rubber composition.

17. The tread of claim 1, wherein the tire is selected from a passenger vehicle tire or a light truck tire.

18. A tread for a tire, the tread comprising:
one or more repeating pitches, each repeating pitch comprising individual pitches having tread blocks with sipes formed therein and disposed longitudinally along the tire tread, each pitch having a pitch length of between 15 mm and 35 mm, wherein the tread blocks have a contact surface adapted for contacting a road;
wherein the tread has a weighted average sipe density D_{w} of between 9 mm⁻¹ and 37 mm⁻¹, wherein a sipe density D_{R} for each of the one or more repeating pitches is:
$${D}_{R} = \frac{( {\sum }_{i = 1}^{n} {L}_{i} ) {P}_{R}}{{W}_{p} \times {L}_{p}} \times 1000 ,$$
where, for one repeating pitch, n is a total number of sipes on one of the individual pitches making up the one repeating pitch, Lᵢ is a projected length of each sipe i onto a lateral axis of the tire tread, Wₚ is a pitch width, Lₚ is the pitch length and P_{R} is a number of individual pitches making up the one repeating pitch, and
wherein the contact surface of the tread blocks comprises a rubber composition based upon a diene elastomer, a plasticizing system and a cross-linking system, wherein the rubber composition has a glass transition temperature of between −40° C. and −15° C. and a shear modulus G* measured at 60° C. of between 0.5 MPa and 1.1 MPa.

19. The tread of claim 18, wherein the contact surface is made entirely of the rubber composition.

20. The tread of claim 18, wherein at least 90 percent of the contact surface is made entirely of the rubber composition.
